(19) United States
(12) Patent Application Publication
(10) Pub. No.: US 2016/0064037 A1
(43) Pub. Date: Mar. 3, 2016

(54) VIDEO APPARATUS AND CONTROL METHOD OF VIDEO APPARATUS

(71) Applicants: Kabushiki Kaisha Toshiba, Tokyo (JP); Toshiba Lifestyle Products & Services Corporation, Tokyo (JP)

(72) Inventors: Megumi Miyazaki, Akishima Tokyo (JP); Tomoki Nakagawa, Akiruno Tokyo (JP)

(21) Appl. No.: 14/626,475

(22) Filed: Feb. 19, 2015

(30) Foreign Application Priority Data
Sep. 3, 2014 (JP) 2014-179401

(51) Int. Cl. G11B 27/10; H04N 5/85; G11B 27/28

(52) U.S. Cl. CPC G11B 27/105; G11B 27/28; H04N 5/85

(57) ABSTRACT

One embodiment provides a video apparatus including: a recorder configured to record a video content including caption information; a setting register configured to set search parameters including a keyword; and a chapter generator configured to extract chapters each including an interval in which the keyword appears in a caption or captions from the video content. The chapter generator extracts the chapters by setting a start point of a period in which a caption containing the keyword is to be displayed first as a chapter start point, and setting a point that comes first after the end of display of a tail caption containing the keyword among a point when a silent interval starts, a point when a prescribed time elapses, and an end point of a packet concerned of the video content consisting of plural packets as a chapter end point.

### CROSS-REFERENCE TO RELATED APPLICATION(S)

This application claims priority from Japanese Patent Application No. 2014-179401 filed on Sep. 3, 2014, the entire contents of which are incorporated herein by reference.

### FIELD

An embodiment described herein generally relates to a video apparatus which extracts scenes a user would be interested in from video contents recorded in a recorder and a control method of such a video apparatus.

### BACKGROUND

With the spread of hard disk drives etc. capable of long-time recording, it has become a common manner to record a video content such as a TV broadcast program for a long time. In addition, it has also become a common manner to tentatively record all programs of all available broadcasting stations and later to view only desired programs.

Since the viewable time of each user is limited, it is preferable that a user is allowed to easily extract scenes which the user would be interested in from many recorded video contents.

For example, when detailed information of recorded programs are available through a network such as the Internet, there may provided a method in which a user can extract only corresponding scenes from these recorded programs by making a keyword search referring to the detailed information. For example, by making a search using the name of an artist as a keyword, the user can extracts scenes and commercial messages associated with the artist.

More preferably, a list of thus-found scenes may be presented so that the user can easily reproduce a desired scene merely by selecting it from the list. For further smooth selection by the user, preview images of these scenes may be presented.

When closed captioning in which lines of actors, a narration, effect sounds, etc. are displayed as captions for hearing-impaired persons is available, a user may be allowed to make a keyword search using such caption information. In the closed captioning, captions are displayed according to a user setting in synchronism with video by superimposing a text for caption display (caption ES (elementary stream)) on a broadcast signal. In the case of the search referring to text information of a caption ES, it is necessary to be connected with the network.

When the above-mentioned methods are simply implemented, only start point information of each scene may be presented in the thus-obtained scene list. In this case, although a user can view a desired shot from its beginning by selecting a scene, the video reproduction continues even if the video of the desired shot ends and it forwards to subsequent not-so-desired shot. To view the next scene found, the user may need to make a manipulation for finishing the display of the current scene and then make a manipulation for selecting the next scene from the scene list again.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 is a block diagram showing the configuration of a video apparatus according to a first embodiment.

FIG. 2 illustrates the structure of a broadcast signal.

FIG. 3 is a flowchart of a control method of the video apparatus according to the first embodiment.

FIG. 4 shows a menu picture of the video apparatus according to the first embodiment.

FIG. 5 shows a search conditions setting picture of the video apparatus according to the first embodiment.

FIGS. 6A-6C illustrate three respective cases of setting of a chapter.

FIG. 7 shows play lists each consisting of chapters in the video apparatus according to the first embodiment.

FIG. 8 is a block diagram showing the configuration of a video apparatus according to a second embodiment.

FIG. 9 is a flowchart of a control method of the video apparatus according to the second embodiment.

FIG. 10 shows a search conditions setting picture of the video apparatus according to the second embodiment.

FIG. 11 shows a keyword candidates display picture of the video apparatus according to the second embodiment.

### DETAILED DESCRIPTION

One embodiment provides a video apparatus including: a recorder configured to record a video content including caption information; a setting register configured to set search parameters including a keyword; and a chapter generator configured to extract chapters each including an interval in which the keyword appears in a caption or captions from the video content. The chapter generator extracts the chapters by setting a start point of a period in which a caption containing the keyword is to be displayed first as a chapter start point, and setting a point that comes first after the end of display of a tail caption containing the keyword among a point when a silent interval starts, a point when a prescribed time elapses, and an end point of a packet concerned of the video content consisting of plural packets as a chapter end point.

### Embodiment 1

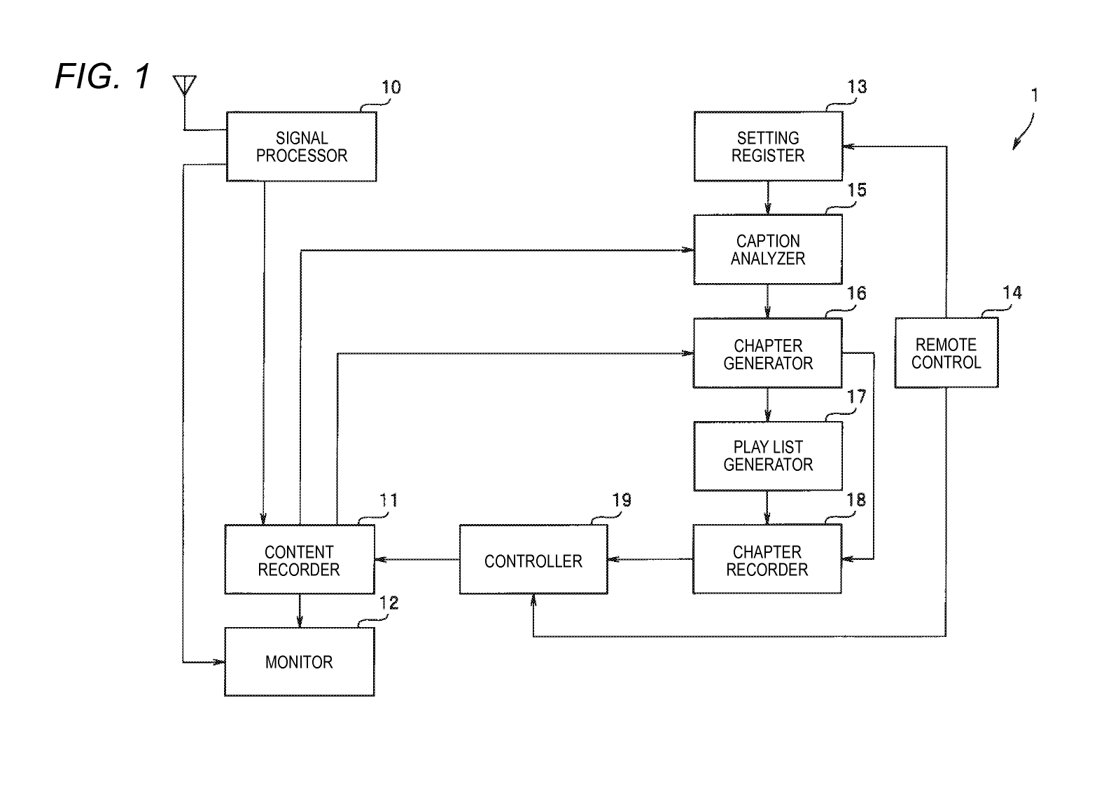

As shown in FIG. 1, a video apparatus 1 according to a first embodiment is a TV receiver which is equipped with a signal processor 10, a content recorder 11, a monitor 12, a setting register 13, a remote control 14, a caption analyzer 15, a chapter generator 16, a play list generator 17, a chapter recorder 18, and a controller 19. One or both of the content recorder 11 and the monitor 12 may be connected externally.

The signal processor 10 receiver a broadcast signal and decodes and separates it into signals representing a video content, that is, a video signal, an audio signal, and a caption signal. That is, the signal processor 10 also has a tuner function. Alternatively, a signal processing function and a tuner function may be implemented as independent elements. Example broadcast signals are a signal transmitted from a broadcasting station wirelessly or by wire (cable broadcast) and a signal that is input from a recording medium such as a DVD or a memory card.

The content recorder 11 functions as a recorder to record plural video contents (programs) each having caption information. The content recorder 11 includes a recording medium such as a hard disk drive, a silicon disk drive having a nonvolatile semiconductor memory, a writable DVD, or the like. Alternatively, the content recorder 11 may include a non-temporary information recording device from which recorded video signals do not disappear even when a power is not supplied thereto. For example, the content recorder 11 may be composed of plural recording devices such as one built-in hard disk drive and two external hard disk drives.

The monitor 12 is a liquid crystal display, an EL (electroluminescence) display, a plasma display, an SED (surface-conduction electron-emitter display), a video projector, a rear projection display, a CRT display (including a flat type), or the like.

The setting register 13 functions as a setting register through which various parameters such as search parameters including a keyword are set using the remote control 14, for example. The caption analyzer 15 analyzes a caption signal and extracts captions containing a keyword.

The chapter generator 16 functions as a chapter generator to extract, from a video content, chapters each of which includes an interval (shot) in which a keyword is to be displayed in a caption(s). The chapter is information for identification of a partial interval of a video content and includes start point information and end point information. The play list generator 17 functions as a play list generator to generate a play list by combining together plural chapters extracted by the chapter generator 16. Using a play list, a user can view, continuously, videos of the plural chapters included in the play list.

At least one of a set of chapters extracted by the chapter generator 16 and a play list generated by the play list generator 17 is stored in the chapter recorder 18. The controller 19 controls the operation of the entire video apparatus 1. The chapter recorder 18 may be implemented as a recording device that is shared with the content recorder 11 or a temporary storage device such as an RAM.

The signal processor 10, the setting register 13, the caption analyzer 15, the chapter generator 16, the play list generator 17, and the controller 19 are implemented as a semiconductor device(s) such as a CPU(s). These elements may be implemented by a common single CPU, or may be implemented by plural respective plural CPUs.

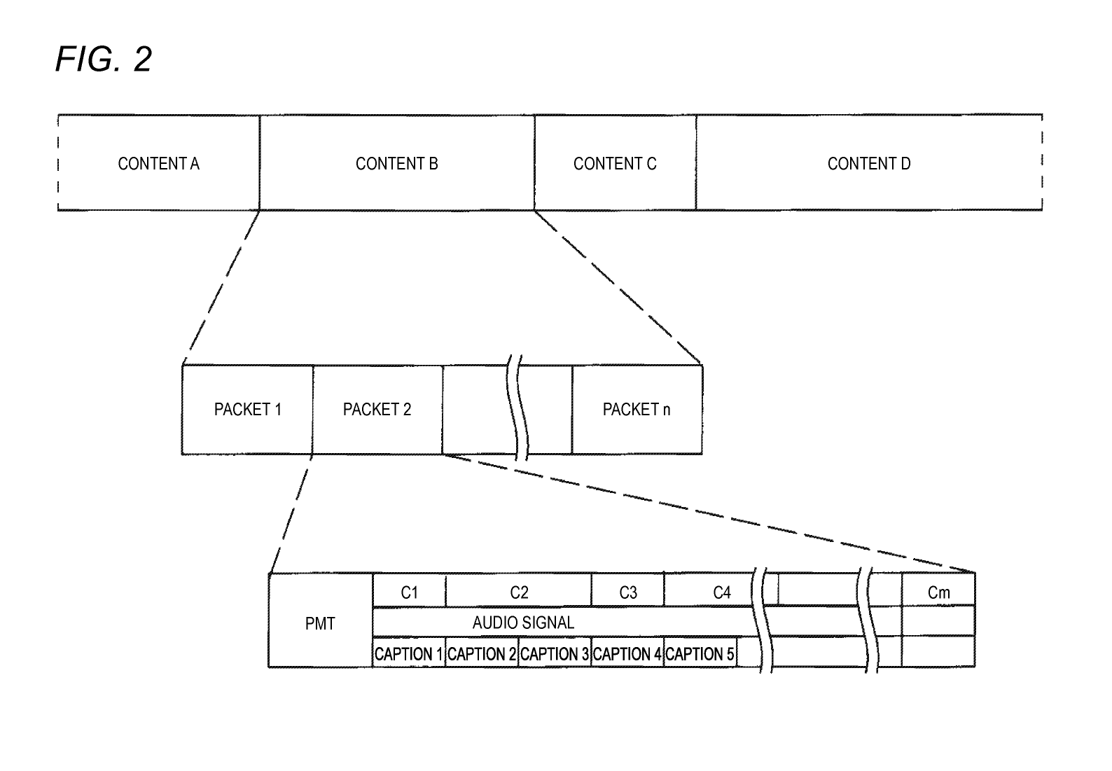

Next, the structure of a broadcast signal will be described with reference to FIG. 2. The broadcast signal consists of plural contents; each content may be a single program and plural contents may constitute a single program. And other kinds of contents such as commercial programs may be inserted between contents of a single program.

Each content consists of plural packets having a certain size. In each packet, a video signal, an audio signal, and a caption signal are multiplexed according to a PMT (program map table) which indicates pieces of information contained in the packet.

A program consists of plural shots each of which is video taken continuously or a short edited version of video taken continuously. A caption may be displayed so as to span plural shots. For example, in a shot C2 shown in FIG. 2, two captions, that is, caption-2 and caption-3, are displayed in this order.

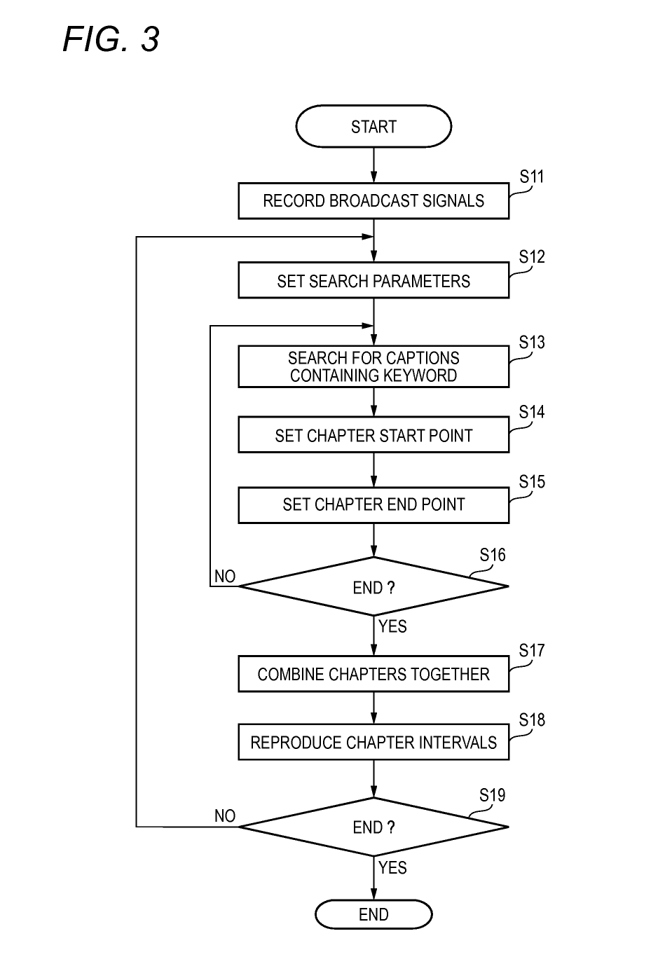

Next, a control method of the video apparatus 1 will be described with reference to a flowchart of FIG. 3.

Step S11: For example, the signal processor 10 receives a multiplexed broadcast signal via a reception antenna, decodes and separates it into a video signal, an audio signal, and a caption signal.

The broadcast signal as processed by the signal processor 10 is stored in the content recorder 11 such as a hard disk drive.

Has plural tuners, the signal processor 10 can process broadcast signals that are received simultaneously from plural broadcasting stations. The content recorder 11 has such a recording capacity as to be able to record broadcast signals on all channels (e.g., ground-wave digital broadcast signals on six channels) of 72 hours received by the signal processor 10. Meanwhile, the content recorder 11 may have a recording capacity larger or smaller than the above-exemplified value. Latest programs of 72 hours are always recorded in the content recorder 11 because new programs are newly recorded in areas where old programs have been recorded if its recording space is filled up.

Step S12: A user sets, through and in the setting register 13, search conditions for viewing of only desired scenes among programs (contents) recorded in the content recorder 11 which are an enormous amount of information.

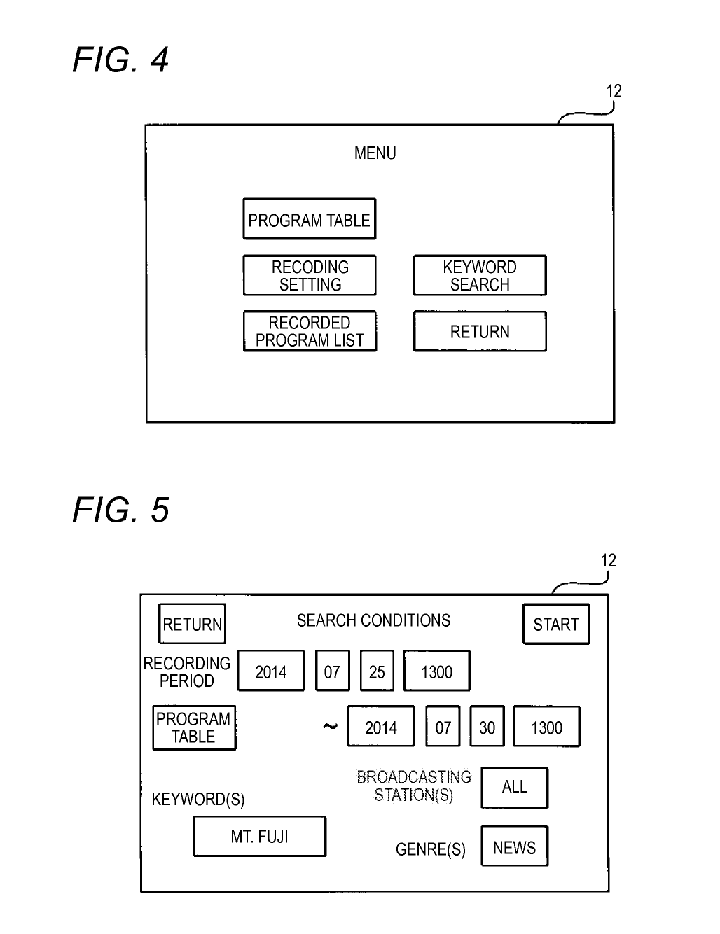

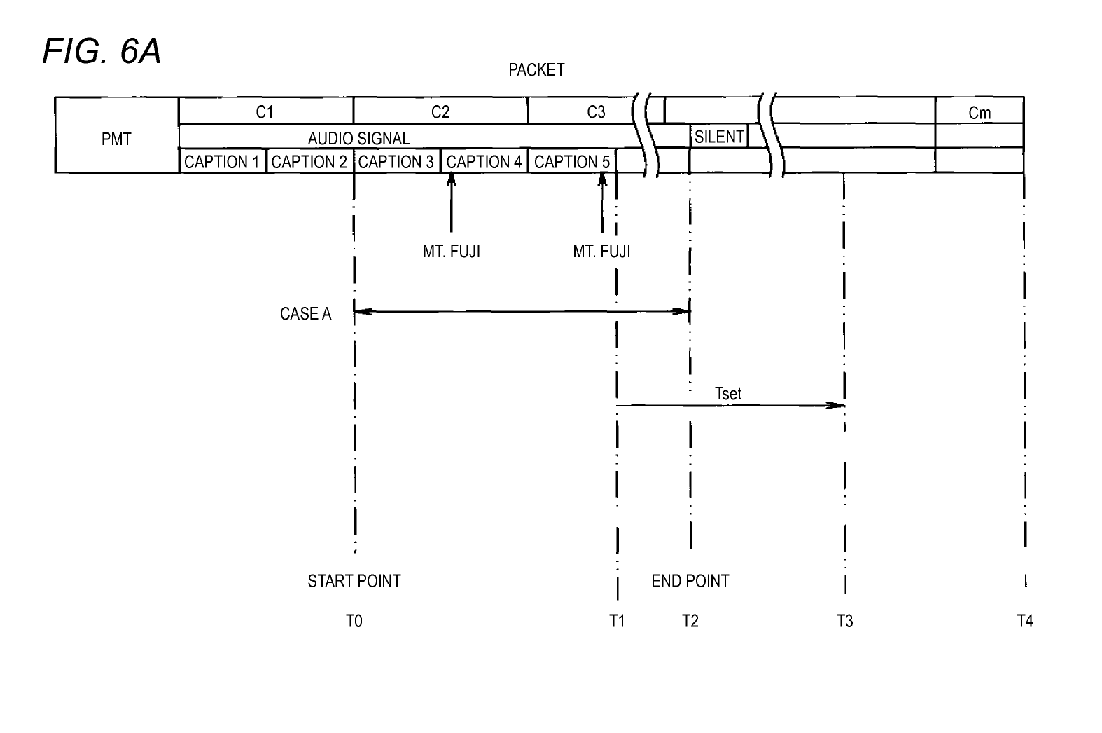

For example, by manipulating the remote control 14, the user selects “keyword search” through a menu picture shown in FIG. 4. In response, a search conditions setting picture shown in FIG. 5 is displayed on the monitor 12. At least a keyword(s) (e.g., “Mt. Fuji”) can be set in the setting register 13 through the search conditions setting picture by a manipulation of the remote control 14 by the user.

Where many contents (e.g., programs of 72 hours that were broadcast from six broadcasting stations) are recorded in the content recorder 11, to enable more proper chapter setting, it is preferable that other search conditions be able to be set in addition to a keyword(s).

For example, in the a search conditions setting picture shown in FIG. 5, a video content recording period (start point and end point), genre(s), and broadcasting station(s) (content provider(s)) are set. A genre of each video content is one of preset categories such as “news,” “movie,” “sports,” and “gourmet” and is acquired from its broadcasting signal or through a network such as the Internet.

It is possible to select a program (or content) from a program table. For example, if a soccer game program that was broadcast yesterday is set as a target program and a player name is set as a keyword, scenes in which the player the user likes is active can be extracted.

If “all” is set for the recording period, broadcasting station(s), genre(s), etc., only the keyword is used as a search condition. If plural keywords, genres, or the like are set, an AND search for scenes containing or satisfying all the keywords, genres, or the like or an OR search for scenes containing or satisfying one of the keywords, genres, or the like is performed.

Step S13: The caption analyzer 15 analyzes a caption ES of each of the contents that satisfy the search conditions set by the setting register 13 among the contents recorded in the content recorder 11 and thereby extracts captions containing the keyword that has been set by the setting register 13. If a search condition(s) other than the keyword is set, the caption analyzer 15 analyzes a caption ES of each of contents that also satisfy that search condition.

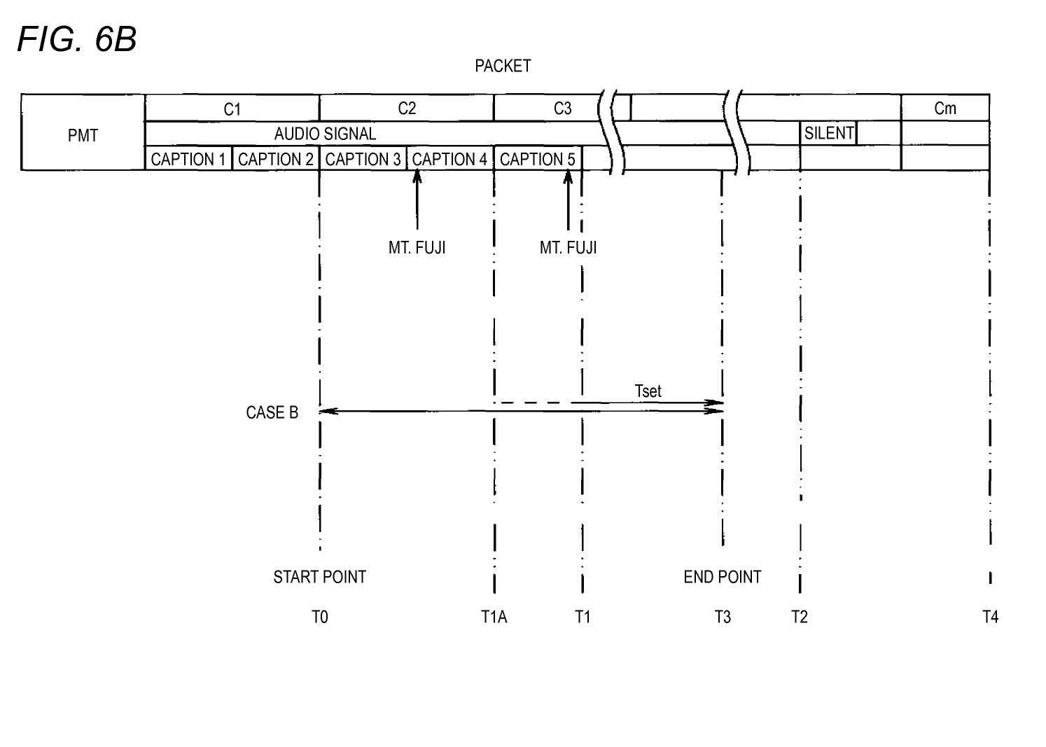

FIGS. 6A-6C show cases in which a keyword “Mt. Fuji” is contained in caption-4 and caption-5 of a certain packet.

Step S14: The chapter generator 16 sets, as a chapter start point, a start point of a period in which a caption(s) extracted by the caption analyzer 15 as one containing the keyword is to be displayed.

FIGS. 6A-6C show the cases in which the keyword “Mt. Fuji” is set. A start point T0 of a shot C2 having caption-4 that contains “Mt. Fuji” first is set as a chapter start point. That is, a period in which a caption is to be displayed is set in units of a shot which was taken continuously. Alternatively, a period in which a caption is to be displayed is set in units of a caption. However, a chapter the user would feel natural can be set by setting a period in which a caption is to be displayed in units of a shot.

Step S15: As shown in FIGS. 6A-6C, the chapter generator 16 sets, as a chapter end point, one that comes first after the end (T1) of display of caption-5 containing the keyword among a point T2 when a silent interval starts (case A shown in FIG. 6A), a point T3 when a prescribed time Tset elapses (case B shown in FIG. 6B), and an end point T4 of the packet (case C shown in FIG. 6C).

In case A shown in FIG. 6A, T2 is earlier than T3 and T4. Therefore, the chapter generator 16 sets, as a chapter end point, the point T2 when a silent period starts after the end (T1) of display of caption-5 which contains the keyword. That is, the chapter generator 16 considers the appearance of the silent period means a change to a scene that is irrelevant to “Mt. Fuji.”

In case B shown in FIG. 6B, T3 is earlier than T2 and T4. Therefore, the chapter generator 16 sets, as a chapter end point, the point T3 when the prescribed time Tset (e.g., 3 minutes) elapses from the end (T1) of display of caption-5 which contains the keyword. That is, the chapter generator 16 considers the lapse of the prescribed time means a change to a scene that is irrelevant to “Mt. Fuji.”

Captions containing a keyword tend to appear successively or many times in a short time in a content. If as in the case of FIG. 6B a caption containing the keyword is to be displayed again before detection of a chapter end point, the prescribed time is measured from the end of display of the last caption containing the keyword (in the case of FIG. 6B, caption-5 in shot C3).

The start point of the prescribed time may be a point other than the end point T1 of display of the last caption containing the keyword, such as its start point T1A or the chapter start point T0.

In case C shown in FIG. 6C, T4 is earlier than T2 and T3. Therefore, the chapter generator 16 sets, as a chapter end point, the end point T4 of the packet of the video content which appears earlier than the point T2 when a silent period starts and the point T3 when the prescribed time Tset elapses from the end (T1) of display of caption-5 which contains the keyword. The packet end point T4 is also the start point of the next packet and is a point where the PMT changes.

Step S16: The chapter extraction processing (steps S14-S16) is performed repeatedly until chapters of all the contents that satisfy the search conditions set by the setting register 13 are extracted.

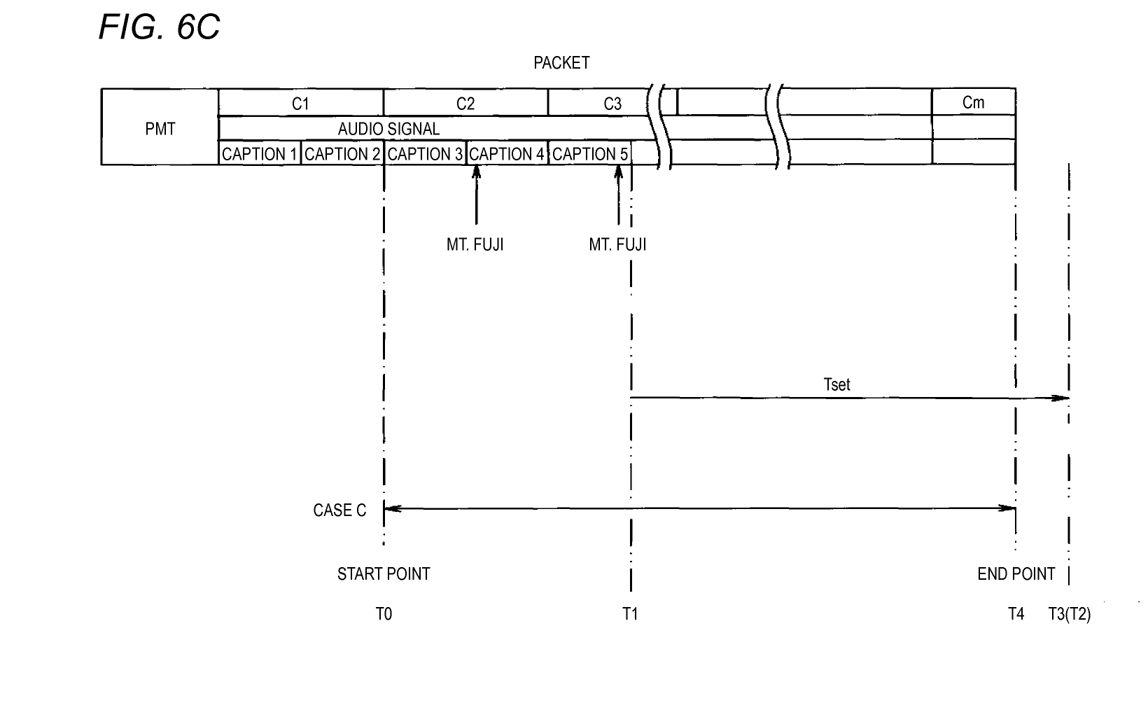

In the video apparatus 1, not only a start point but also an end point of each of intervals in which the keyword is to be displayed in a caption(s) are extracted; in an example shown in part X of FIG. 7, three chapters, that is, chapter-1 to chapter-3, are thus set.

For example, preview images of chapter-1 to chapter-3 are list-displayed on the monitor 12. The video apparatus 1 may be configured so as to perform a search again when a new search condition is input by a user if the number of chapters set is too large.

If the user selects one of the chapters that are displayed on the monitor 12 as the keyword search result, reproduction of the intervals, relating to the keyword, of the contents is started. The reproduction is finished automatically upon the end of reproduction of the intervals relating to the keyword.

In the video apparatus 1, a transition may be made automatically to a play list generation step S17 without displaying the chapters (chapter-1 to chapter-3). However, the play list generator 17 is not an essential unit of the video apparatus 1. Since a chapter is set so as to include not only a start point but also an end point of each of intervals in which the keyword is to be displayed, the video reproduction is finished automatically upon completion of display of videos relating to the keyword. The video apparatus 1 is convenient to use even if a play list is not generated.

Step S17: As shown in part Y of FIG. 7, the play list generator 17 generates a play list I by combining together the chapters (chapter-1 to chapter-3) extracted by the chapter generator 16.

Step S18: The videos and audios of the intervals of the chapters (chapter-1 to chapter-3) included in the play list are reproduced automatically. That is, the user can view the intervals of all the chapters merely by making a single set of manipulations for setting search parameters.

For example, only a single set of manipulations of setting a keyword “Tokyo” allows the user to view, continuously, all scenes whose captions contain the word “Tokyo” among videos of all broadcast programs of 72 hours that were broadcast on six ground-wave digital broadcast channels. As such, the video apparatus 1 that is equipped with the chapter generator 16 is particularly convenient to use.

It is preferable that a user be able to delete an unnecessary chapter from the plural chapters of a play list or combine play lists together. Since a play list generated, it is possible to record only videos indicated by the play list on a DVD.

Step S19: If the user selects a new keyword (S18: no), the process returns to step S12 and the above-described steps are executed again. As a result, as shown in part Z of FIG. 7, a new play list II is generated by combining chapter-1 to chapter-5 together.

If the user stores the play list in the chapter recorder 18 that has a nonvolatile recorder, the user can view videos indicated by the play list again at a later date.

On the other hand, the process is finished if the user finishes the search (S18: yes).

The above-described control method of the video apparatus 1 is very convenient to use because chapters are extracted according to the tastes of a user and a play list is generated further.

### Embodiment 2

A video apparatus 1A according to a second embodiment will be described below. Since the video apparatus 1A is similar to the video apparatus 1, constituent units having, in the video apparatus 1, corresponding ones that function in the same manners will be given the same reference symbols as the latter and descriptions therefor will be omitted.

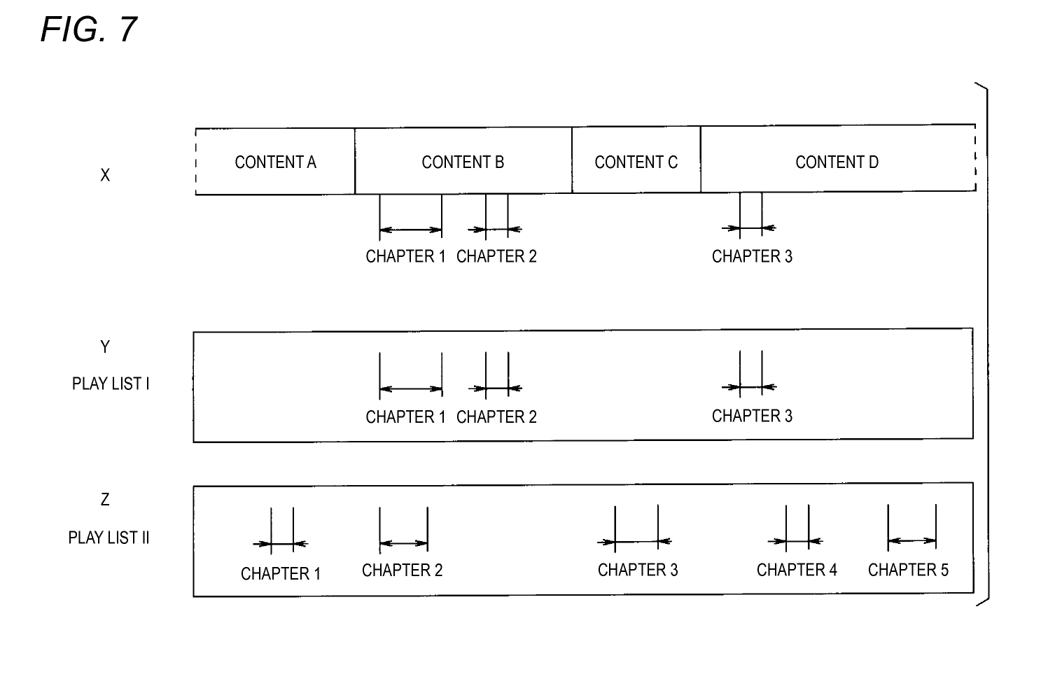

As shown in FIG. 8, the video apparatus 1A is equipped with a keyword extractor 20 (keyword extractor). The keyword extractor 20 extracts, as keyword candidates, words or phrases that appear at high frequencies by analyzing the caption information of a video content. The keyword extractor 20 may be implemented by a CPU. Alternatively, the keyword extractor 20 may be implemented along with the caption analyzer 15 by the common CPU.

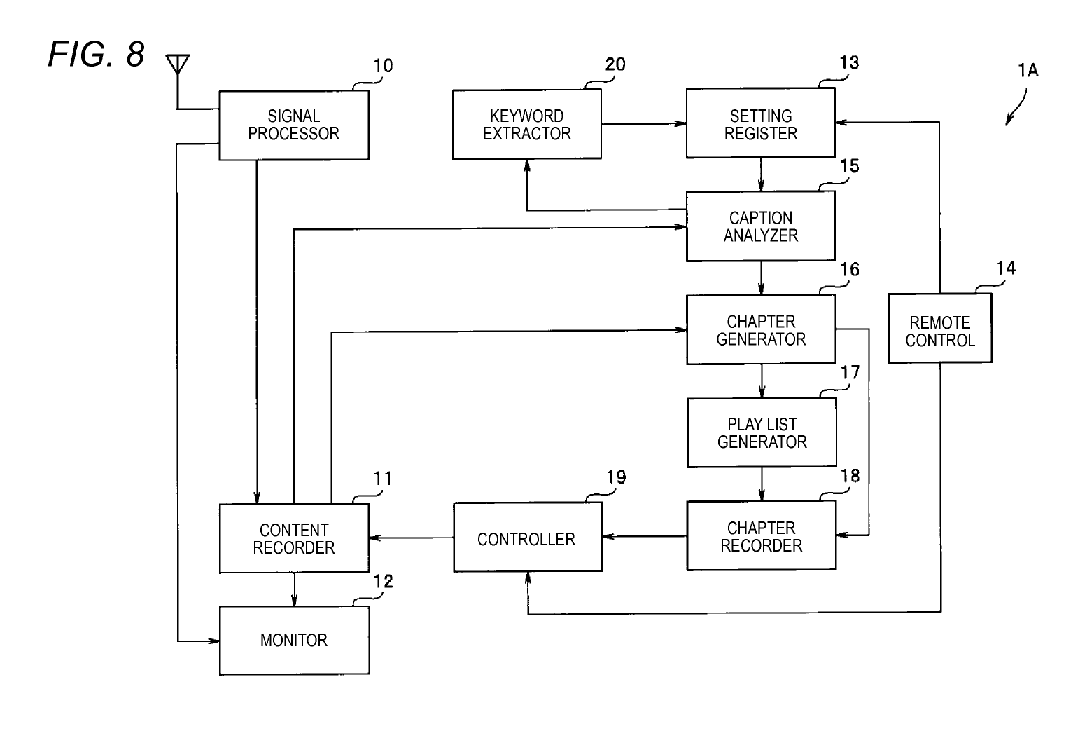

Referring to a flowchart of FIG. 9, keyword candidates extraction processing is performed at step S12A. The keyword extractor 20 extracts topical words and phrases from each of the programs recorded in the content recorder 11.

At step S12, one of the keyword candidates is selected by the user and set.

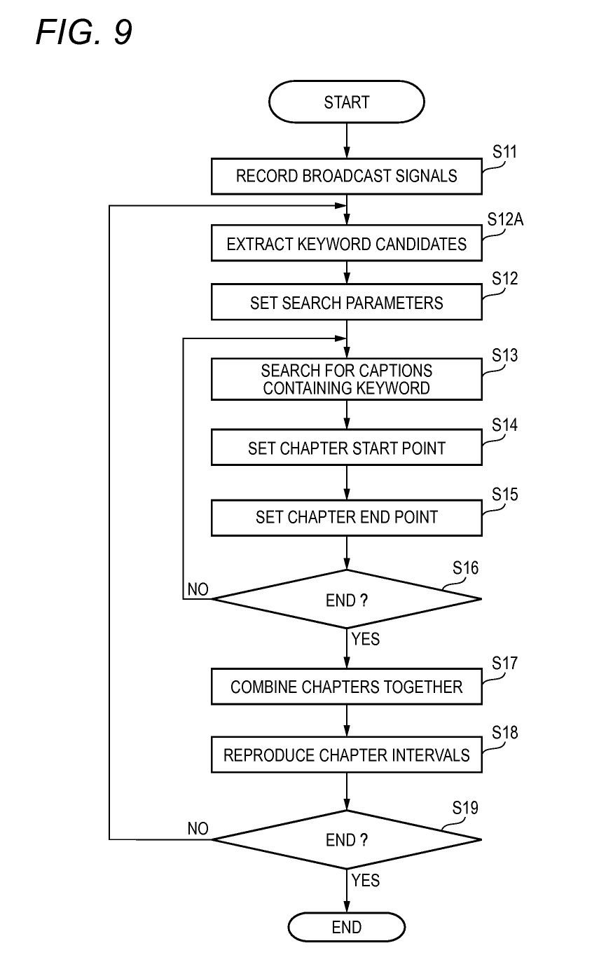

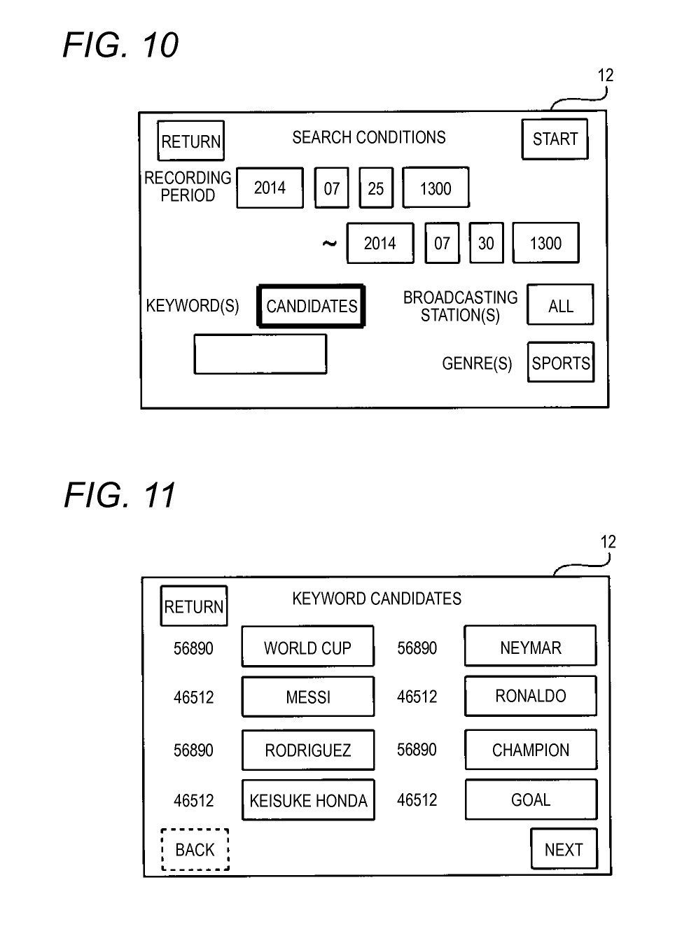

In the video apparatus 1A, for example, as shown in FIG. 10, an option “candidates” is displayed adjacent to the keyword setting box in the search conditions setting picture. If the user selects “candidates,” as shown in FIG. 11 keyword candidates are displayed in the form of a list. In the keyword candidates display picture shown in FIG. 11, the keyword candidates are list-displayed together with respective numbers of appearances.

If a video contents recording period etc. are set in the search conditions setting picture, the keyword extractor 20 extracts keyword candidates for a set of contents that are in the thus-set range.

For example, by setting, as a target program, a soccer game program that was broadcast yesterday and having keyword candidates displayed, the user can recognize the names of players who were active in that soccer game. Players who appear frequently in captions can be considered players who were active the game.

The video apparatus 1A is convenient to use because it allows a user to view only videos of topical scenes in a short time. Furthermore, setting search conditions that are narrow down to extract a prescribed program (content) allows the user to recognize its outline.

Although the embodiments have been described above, they are just examples and should not be construed as restricting the scope of the invention. Each of these novel embodiments may be practiced in various other forms, and part of it may be omitted, replaced by other elements, or changed in various manners without departing from the spirit and scope of the invention. These modifications will also fall within the scope of the invention as claimed.

1. A video apparatus, comprising:
a recorder configured to record a video content including caption information;
a setting register configured to set search parameters including a keyword; and
a chapter generator configured to extract chapters each including an interval in which the keyword appears in a caption or captions from the video content, by
setting a start point of a period in which a caption containing the keyword is to be displayed first as a chapter start point, and
setting a point that comes first after the end of display of a tail caption containing the keyword among a point when a silent interval starts, a point when a prescribed time elapses, and an end point of a packet concerned of the video content consisting of plural packets as a chapter end point.

2. The video apparatus of claim 1, further comprising:
a play list generator configured to generate a play list by combining the plural chapters extracted by the chapter generator.

3. The video apparatus of claim 2,
wherein the search parameters include at least one of a video content recording period, a genre and a provider.

4. The video apparatus of claim 3, further comprising:
a keyword extractor configured to analyze the caption information of the video content and to extract, as keyword candidates, words or phrases that appear at high frequencies,
wherein the keyword is set from among the keyword candidates through the setting register.

5. A video apparatus control method, comprising:
recording a video content including caption information into a recorder;
setting search parameters including a keyword through a setting register; and
extracting chapters each including an interval in which the keyword appears in a caption or captions from the video content using a chapter generator, by
setting a start point of a period in which a caption containing the keyword is to be displayed first as a chapter start point, and setting a point that comes first after the end of display of a tail caption containing the keyword among a point when a silent interval starts, a point when a prescribed time elapses, and an end point of a packet concerned of the video content consisting of plural packets as a chapter end point.
